(19) United States
(12) Patent Application Publication
(10) Pub. No.: US 2010/0068489 A1
(43) Pub. Date: Mar. 18, 2010

(54) Wear-resistant, carbon-doped metal oxide coatings for MEMS and nanoimprint lithography

(75) Inventors: Boris Kobrin, Dublin, CA (US); Romuald Nowak, Cupertino, CA (US); Jeffrey D. Chinn, Foster City, CA (US)

Correspondence Address: Peter Martine, Esq.;Martine Penilla & Gencarella, LLP, 710 Lakeway Drive, Suite 200, Sunnyvale, CA, 94085, US

(73) Assignee: Applied Microstructures, Inc.

(21) Appl. No.: 12/150,249

(22) Filed: Apr. 24, 2008

Related U.S. Application Data
(63) Continuation-in-part of application No. 12/072,086, filed on Feb. 22, 2008.
(60) Provisional application No. 60/903,151, filed on Feb. 23, 2007.

(51) Int. Cl. B32B 5/00; B32B 9/00; B05D 5/12; B28B 7/38

(52) U.S. Cl. 428/220; 428/702; 428/697; 427/126.3; 427/126.4; 427/133

(57) ABSTRACT

The carbon-doped metal oxide films described provide a low coefficient of friction, typically ranging from about 0.05 to about 0.4. Applied over a silicon substrate, for example, the carbon-doped metal oxide films provide anti-stiction properties, where the measured work of adhesion for a coated MEMS cantilever beam is less than 10 μJ/m². The films provide unexpectedly low water vapor transmission. In addition, the carbon-doped metal oxide films are excellent when used as a surface release coating for nanoimprint lithography. The carbon content in the carbon-doped metal oxide films ranges from about 5 atomic % to about 20 atomic %.

The present application is a continuation-in-part application of U.S. application Ser. No. 12/072,086, titled “Durable Conformal, Wear-Resistant Carbon-Doped Metal Oxide-Comprising Coating”, which was filed on Feb. 22, 2008, which claims priority under U.S. Provisional Application Ser. No. 60/903,151 filed Feb. 23, 2007, and titled: “Durable, Protective Anti-Stiction Functional Coating”. U.S. application Ser. No. 12/072,086 and Provisional Application No. 60/903,151 are hereby incorporated by reference in their entireties. In addition, the present application is related to a series of patent applications pertaining to the application of thin film coatings on various substrates, particularly including the following applications, each of which is hereby incorporated by reference in its entirety: U.S. application Ser. No. 10/759,857, filed Jan. 17, 2004, and titled: Apparatus And Method For Controlled Application Of Reactive Vapors To Produce Thin Films and Coatings; U.S. application Ser. No. 11/112,664, filed Apr. 21, 2005, and titled: Controlled Deposition Of Multilayered Coatings Adhered By An Oxide Layer; U.S. application Ser. No. 10/912,656, filed Aug. 4, 2004, and titled: Vapor Deposited Functional Organic Coatings; and U.S. patent application Ser. No. 11/447,186, filed Jun. 5, 2006, and titled: Protective Thin Films For Use During Fabrication Of Semiconductors, MEMS, and Microstructures.

### BACKGROUND OF THE INVENTION

1. Field of the Invention

The present invention is related to a carbon-doped alumina coating which has application as a MEMS (Micro-Electro-Mechanical Systems) surface protective, functional film. The present invention is also related to the use of carbon-doped metal oxide coatings in the field of nanoimprint lithography.

2. Brief Description of the Background Art

This section describes background subject matter related to the invention, with the purpose of aiding one skilled in the art to better understand the disclosure of the invention. There is no intention, either express or implied, that the background art discussed in this section legally constitutes prior art.

Protective coatings currently used in the manufacture of MEMS (Miccro-Electro-Mechanical Systems) devices include but are not limited to: moisture barrier coatings, oxidation barriers, anti-stiction coatings, “release” coatings, protective coatings for microdevices such as microfluidic devices, ink jet heads, thin film heads, and other electronic and optical devices.

Currently known fluorocarbon coatings, such as self-assembled monolayers (SAMs) are used to provide a hydrophobic surface function; however, these coatings do not offer sufficient wear resistance. This is particularly true with respect to micromechanical or microelectromechanical devices, in which a mechanical contact (sliding, touching, or physical interaction between the parts) requires durable, protective and non-sticky (non-tacky) films. Nanoimprint lithography is an additional field where there is a need for a low surface energy release layer over the surface of the nanoimprint lithography mold, and the low surface energy release layer needs to be wear resistant.

Wear-resistant, low surface energy coatings of silicon carbide (SiC) can be deposited by a chemical vapor deposition (CVD) method, providing considerable degree of protection, specifically wear reduction. W. Ashurst et al. in an article entitled “Tribological impact of SiC encapsulation of released polycrystalline silicon microstructures”, Triboloby Letters, v. 17, 2004, 195-198, describe a method for coating released polysilicon microstructures with a thin, conformal coating of SiC derived from a single source precursor. The precursor was 1,3-disilabutane (DSB). This coating method has been successfully applied to micromechanical test devices which allow the evaluation of friction and wear properties of the coating. Data for the coefficient of static friction of the SiC coatings produced from DSB is presented in FIG. 1 of this application, for reference purposes. FIG. 1 shows a graph 100 which illustrates the coefficient of friction, μₛ, on axis 104, as a function of the number of wear cycles in millions on axis 102. The wear testing was done using a polysilicon sidewall friction tester of the kind described by W. R. Ashurst et al. in Tribology Lett. 17 (2004) 195-198. Curve 106 represents wear testing of an oxidized polysilicon substrate with a native oxide surface. Curve 108 represents wear testing of an anti-adhesion coating produced from vapor deposited DDMS over the surface of the sidewall friction tester. Curve 110 represents wear testing of a silicon substrate which was treated with an oxygen plasma, followed by deposition of an SiC coating. The SiC coating was deposited by plasma assisted low pressure CVD, from a SiCl₄ precursor at about 800° C., using a technique generally known in the art. The wear was examined using scanning electron microscopy (SEM) on devices which were cycled repetitively under a nominal load. This testing shows that the application of an SiC coating having a thickness of about 40-50 nm provides good wear resistance as well as a significant reduction in friction on a micro scale.

A wear-resistant low surface energy coating which can be produced at low temperatures (in the range of about 200° C. or less) would be highly desirable. Such a coating can be produced using atomic layer deposition (ALD) films produced at relatively low temperatures in the range 177° C.; however, the coating surface energy does not appear to be low enough to provide efficient anti-stiction and passivation functions for MEMS. For example, T Mayer et al., in an article entitled: “Atomic-layer deposition of wear-resistant coatings for microelectromechanical devices”, Applied Physics Letters, v.82 N17, 28 Apr., 2003, describe a thin, conformal, wear-resistant coating applied to a micromachines Si surface structure by atomic-layer deposition (ALD). Ten nm thick films of Al₂O₃ were applied to a silicon surface using a binary reaction sequence with precursors of trimethyl aluminum and water. Deposition was carried out in a viscous flow reactor at 1 Torr and 168° C., with N2 as a carrier gas, Cross-section transmission electron microscopy analysis showed that the films were uniform to within 5% on MEMS device structures having an aspect ratio ranging from 0 to greater than 100. The Al₂O₃ film produced was stoichiometric.

Preliminary friction and wear measurements for the 10 nm thick Al₂O₃ films showed a friction coefficient of 0.3 for a Si₃N₄ ball sliding on a flat Al₂O₃-coated substrate, and less wear particle generation than for a native-oxide-coated silicon substrate. At the time of publication of the paper, the nature of the wear and failure process as a function of applied load had not yet been determined.

There remains a need in the industry for a low energy coating which can provide efficient anti-stiction and passivation functions for mems and which can be produced at low temperatures which are more tolerable to various MEMS substrates.

### SUMMARY

A durable, functional film useful in protecting MEMS device surfaces and for application to the contact surfaces of nanoimprint lithography molds can be produced by doping an inorganic metal oxide film with relatively high levels of carbon. Properly doped films exhibit both anti-stiction and lubricative properties. The inorganic metal oxide film is selected from the group consisting of aluminum oxide, titanium oxide, zirconium oxide, hafnium oxide, tantalum oxide, and combinations thereof. Aluminum oxide and titanium oxide work particularly well. The atomic percent of carbon dopant which is added ranges from about 5 atomic % to 20 atomic % of the film composition. Experimental results have confirmed that carbon dopant ranging from about 10 atomic % to about 15 atomic % of the film content works particularly well.

The carbon doping can be carried out using a metal oxide deposition reaction at relatively low temperatures, less than about 150° C., which produces limited oxidation. A precursor organo-metallic compound used to deposit the metal oxide via a vapor deposition technique such as atomic layer deposition, when reacted at a sufficiently low temperature, produces a metal oxide containing unoxidized (incompletely reacted) hydrocarbon, which becomes incorporated as carbon into the metal oxide film. This is contrary to traditional semiconductor manufacturing requirements, where metal oxide films are grown to be as pure as possible, to provide improved dielectric isolation performance. In one embodiment of the present invention, for example, a carbon doped aluminum oxide film can be deposited from TMA and H₂O using atomic layer deposition, for example, at a temperature in the range of about 25° C. to about 120° C. Or, a titanium oxide film can be deposited from TiCl₄ and H₂O using atomic layer deposition, at a temperature in the range of about 25° C. to about 120° C.

The incorporation of carbon into the oxide film results in a relatively durable carbonized metal oxide film which exhibits lubricative and anti-stiction properties. This has been illustrated using a microfabricated polysilicon sidewall wear tester. Such carbon doped metal films preform particularly well. For example, an alumina film doped with about 10 atomic % carbon exceeds the performance of the best data published for a silicon carbide film.

### BRIEF DESCRIPTION OF THE DRAWINGS

FIG. 1 shows comparative examples for prior art competitive materials. FIG. 1 shows a graph 100 which illustrates the coefficient of friction, μₛ, on axis 104, as a function of the number of wear cycles in millions on axis 102. Curve 106 represents the wear testing of a polysilicon substrate with a native oxide surface. Curve 108 represents the wear testing of an anti-adhesion coating produced from vapor deposited DDMS over the surface of a silicon substrate, and Curve 110 represents the wear testing of a silicon substrate which was treated with an oxygen plasma, followed by deposition of an SiC coating.

FIG. 2 shows a graph 200 illustrating the XPS spectra taken of a carbon-doped alumina layer deposited using molecular vapor deposition (MVD) at low temperature. The signal strength at the binding energy indicative of carbon clearly illustrates the presence of carbon in the aluminum oxide film.

FIG. 3 shows the roughness of a carbon-doped alumina film, as illustrated by an atomic force microscope scan. The surface morphology is very smooth with an RMS of 0.170 nm.

FIGS. 4A and 4B show cantilever beam arrays coated with low temperature carbon-doped aluminum oxide. The polysilicon detachment length is greater than 1500 which corresponds with a work of adhesion of less than 1 μJ/m².

FIG. 5A shows an SEM image of a polysilicon wear testing structure 500, including beam 502 and post 504, which can be used to test sidewall friction along a beam surface, for example. The scale 506 shows 20 μm, illustrating the size of the elements shown.

FIG. 5B shows a comparative (prior art) view 520 of contacting parts which were coated with vapor deposited DDMS, a beam 522 and a post 524, where the contacting parts were subjected to 250,000 wear cycles. Substantial wear (scarring) is shown on the beam, and wear debris is shown at the edge of the rubbed part of the beam 522 and on the anchored post 524.

FIG. 5C shows an SEM photomicrograph 530 of the contacting parts of a polysilicon substrate coated with a carbon-doped aluminum oxide film embodiment of the present invention, after the contacting beam 532 and post 534 were subjected to 1,000,000 wear cycles.

FIGS. 6A-6C show a set of comparative schematics of the steps of the nanoimprint process used prior to the present invention. FIGS. 7A-7C show a set of schematics of the steps of the nanoimprint process which employs the present invention.

FIG. 6 A illustrates step 1 of the prior nanoimprinting process, where the assembly 600 includes a patterned mold 606 is positioned above a polymeric material 604 (resist) which is to be patterned. The polymeric material 604 overlies a substrate 602.

FIG. 6B illustrates step 2 of the prior nanoimprinting process, where the patterned mold 606 is been pressed against the surface of polymeric material 604 to leave an imprint, and then withdrawn above the surface of polymeric material 604. There is some sticking of the surface of the mold 600 to the surface of polymeric material 604.

FIG. 6C illustrates step 3 of the prior nanoimprinting process, where the patterned mold 606 is fully withdrawn above the surface of polymeric material 604. The shape of the imprint left in polymeric material 604 does not match the inverse shape of the pattern in mold 606, because of sticking of the polymeric material 604 to the mold 606.

FIG. 7 A illustrates step 1 of an embodiment of a nanoimprinting process which employs the present invention. The assembly 700 shows a patterned mold 706, the surface of which is covered with a low surface energy coating 707 of the kind used in the present invention. Mold 706 is positioned above a polymeric material 704 (resist) which is to be patterned. The polymeric material 704 overlies a substrate 702.

FIG. 7B illustrates step 2 of the embodiment of a nanoimprinting process which employs the present invention. The assembly 700 shows the patterned mold 706 with low surface energy coating 707 on its surface having been pressed against the surface of polymeric material 704 to leave an imprint.

FIG. 7C illustrates step 3 of the embodiment of a nanoimprinting process which employs the present invention. The assembly 700 shows the patterned mold 706 having been fully withdrawn above the surface of polymeric material 704. The shape of the imprint left in polymeric material 704 matches the inverse shape of the pattern in mold 706, because there has been no sticking of the polymeric material 704 to the mold 706.

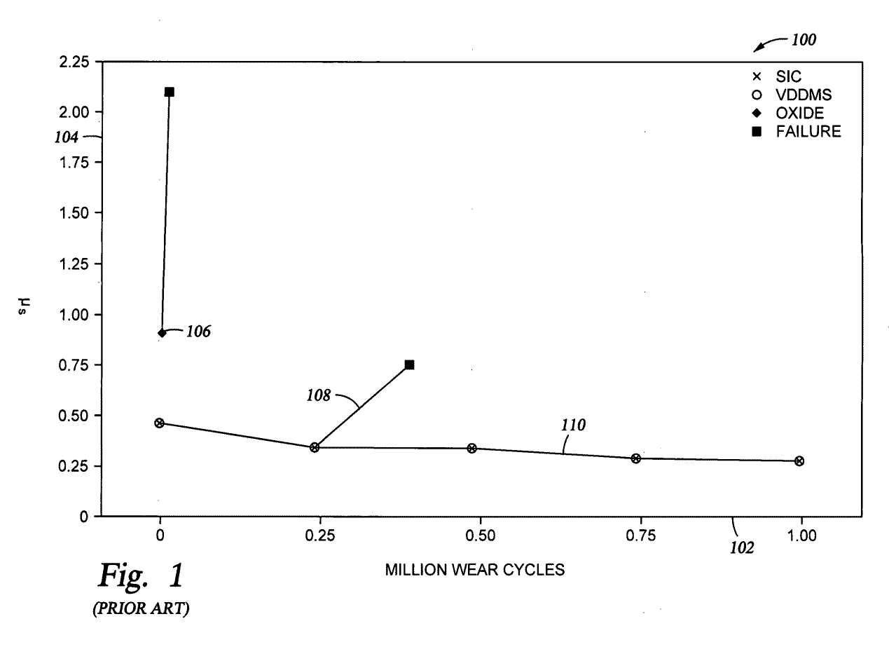

### DETAILED DESCRIPTION OF THE PREFERRED EMBODIMENTS

As a preface to the detailed description, it should be noted that, as used in this specification and the appended claims, the singular forms “a”, “an”, and “the” include plural referents, unless the context clearly dictates otherwise.

When the word “about” is used herein, this is intended to mean that the nominal value presented is precise within ±10%.

One aspect of the invention relates to an atomic vapor deposition method of the kind which can be used to produce carbon-doped oxide films which are embodiments of the present invention. Another aspect of the present invention relates to various embodiment carbon-doped oxide films, of the kind which can be applied to MEMS device surfaces to provide a wear-resistant and anti-stiction performance which was not available prior to the present invention.

A durable, conformal, wear-resistant film useful in protecting MEMS device surfaces can be produced by doping an inorganic metal oxide film with relatively high levels of carbon. Properly doped films exhibit both anti-stiction and lubricative properties. The inorganic metal oxide film is selected from the group consisting of aluminum oxide, titanium oxide, zirconium oxide, hafnium oxide, tantalum oxide, and combinations thereof. Aluminum oxide, titanium oxide, and combinations thereof work particularly well. The atomic percent of carbon dopant which is added typically ranges from about 5 atomic % to 20 atomic % of the film composition. Experimental results have confirmed that a carbon dopant concentration ranging from about 10 atomic % to about 15 atomic % of the film content works particularly well.

The carbon doping can be carried out using a metal oxide deposition reaction at relatively low temperatures, which produces limited oxidation. A precursor organo-metallic compound used to deposit the metal oxide via a vapor deposition technique such as atomic layer deposition, when reacted at a sufficiently low temperature, produces a metal oxide containing unoxidized (incompletely reacted) hydrocarbon, which becomes incorporated as carbon into the metal oxide film. This is contrary to traditional semiconductor manufacturing requirements, where metal oxide films are grown to be as pure as possible, to provide improved dielectric isolation performance.

### EXAMPLES OF ATOMIC LAYER DEPOSITION OF CARBON-DOPED METAL OXIDE FILMS FROM ORGANO-METALLIC PRECURSORS

### Example One

Pure alumina films can be deposited using various vacuum deposition methods. Examples include physical vapor deposition (PVD), which is typically sputtered deposition, but may be deposition from evaporated material, and atomic layer deposition (ALD), not by way of limitation.

In an ALD process, thin layers of metal oxides may be deposited using a variety of organometallic precursors which are commonly known in the art. After reading the present disclosure, one of skill in the art may produce carbon-doped metal oxide films using an ALD process where the precursor for film formation is organometallic alone, organometallic with water, and organometallic with ozone, by way of example and not by way of limitation. For purposes of illustrating an embodiment of the invention which is likely to be used frequently, employment of an organometallic precursor in combination with water is described. Carbon-doped metal oxide films can be tailored easily when deposited using two or more different vapor phase reactants. In the case of a two reactant process, the substrate surface is contacted with a dose of vapor from a first precursor, followed by pumping away of any excess unreacted vapor. Subsequently, the substrate surface is contacted with a dose of vapor from the second precursor, which is allowed to react with the first precursor which is present on the substrate surface, then any excess unreacted vapor is pumped away. This process may be repeated a number of times, with each repetition being considered to be one “cycle”. The number of cycles determines the total thickness of the deposited film/layer. In each step of a cycle, it is important that the amount of material deposited on the substrate surface is uniform, and that at least a minimum coverage of the surface, i.e. a saturation of the surface is achieved. To deposit a metal oxide by ALD, the first precursor is typically an organo-metallic material, and the second precursor is typically water.

In an embodiment of the present invention, the commonly used ALD process has been changed in order to incorporate carbon from the organo-metallic precursor into the deposited film. To produce a carbon-doped aluminum oxide film, where the carbon atomic content of the film was 10%, the following process was used.

The processing chamber used to produce the carbon-doped aluminum oxide film was an MVD Model 100, available from Applied Microstructures, Inc. of San Jose, Calif. The temperature of the processing chamber and the sample was 65° C. The processing chamber was purged with nitrogen gas initially and between sequential exposures to precursor “A” which was trimethylaluminum (TMA) and precursor “B” which was water vapor. Ten nitrogen purge cycles were carried out after exposure of the substrate to TMA, and after exposure of the substrate to water vapor. Nitrogen gas pressure during a purge was in the range of about 10 Torr. In addition, the chamber pressure was pumped down to a base pressure of 0.1 Ton after the nitrogen purge and prior to the charging of water vapor.

While the nominal values provided above are with respect to this Example One, one skilled in the art may use a nitrogen gas pressure during the purge which is in the range of about 1 Torr to about 100 Torr, typically about 10 Torr to about 20 Torr. In addition, the pump down of the chamber between charging of a first precursor and the charging of a second precursor may employ a base pressure ranging from about 0.001 Torr and about 1 Ton, typically from about 0.01 Torr and about 0.1 Torr.

The pressure in the processing chamber during the charge of each TMA injection was 0.2 Torr, and the pressure in the processing chamber during each water vapor injection was 0.8 Torr. The substrate temperature was at 65° C. during a TMA reaction period, and the time period of substrate exposure to the TMS was 15 seconds, prior to purge with nitrogen gas, followed by a subsequent pump down to base pressure. The substrate temperature was at 65° C. during a water vapor reaction period, and the time period of substrate exposure to the water vapor was 15 seconds prior to purge with nitrogen gas, followed by a subsequent pump down to base pressure. Approximately 1.5 Å of carbon-doped film was deposited during each single deposition cycle. Fifty deposition cycles were carried out to form a film having a thickness of 77 Å.

While the nominal values provided above are with respect to this Example One, one skilled in the art may use a TMA injection pressure in the processing chamber ranging from about 0.01 Torr to about 1.0 Torr, typically ranging from about 0.1 Torr to about 0.5 Torr. Pressure during the water vapor injection may range from about 0.01 Ton to about 5 Torr, typically ranging from about 0.1 Ton to about 1 Torr. The substrate temperature during formation of the film may range from about 35° C. to about 120° C., and is typically in the range of from about 50° C. to about 80° C.

The number of deposition cycles is typically in the range from about 10 to about 100, depending on the required film thickness, with each cycle producing from about 1.2 Å to about 2.0 Å of film thickness. As a result, the protective film/layer thickness is in the range of about 20 Å to about 400 Å, and is typically in the range of about 20 Å to about 100 Å. One of skill in the art will recognize that the deposition rate of the carbon-doped film of the present invention is typically higher than the deposition rate of the previously produced pure aluminum oxide film.

An optional SAM fluorocarbon film may be deposited on top of the doped alumina film using methods generally available, to provide an additional hydrophobic surface property or other functional property. This may be used to prevent stiction during manufacturing, for example, with the knowledge that the SAM will not hold up well under frictional wear in-use conditions. Multi-layered, laminated oxide film may be formed where a portion of the oxide layers are carbon-doped layers.

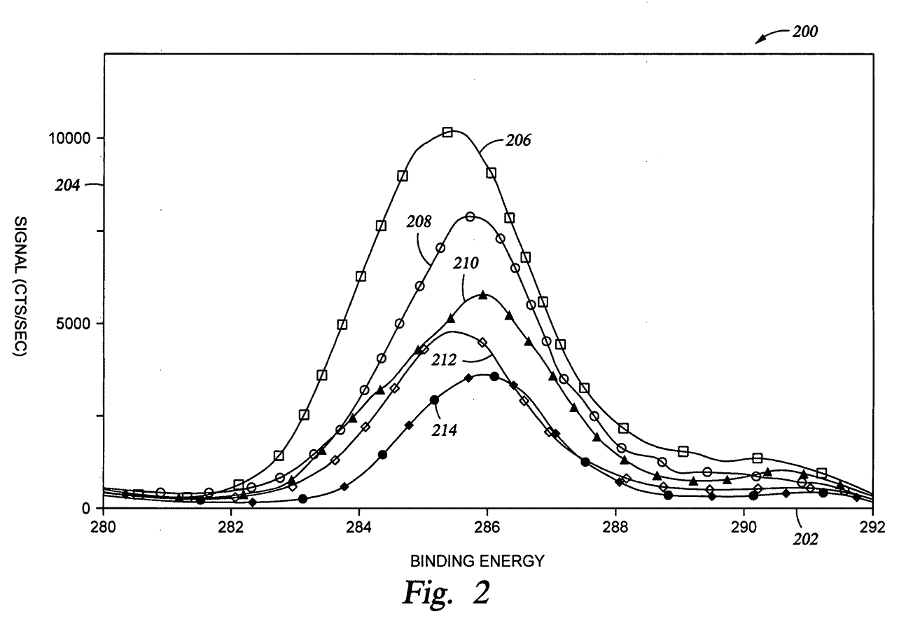

FIG. 2 shows a graph 200 illustrating the XPS spectra taken of a carbon-doped alumina layer deposited using molecular vapor deposition (MVD) at low temperatures. The Binding Energy in EV is shown on the axis 202, and indicates the presence of carbon. The signal strength for the presence of carbon in cts/sec is shown on axis 204. Curve 206 represents a carbon-doped aluminum oxide film which was deposited at a substrate temperature of 65° C. Curve 208 represents a carbon-doped aluminum oxide film which was deposited at a substrate temperature of 55° C. Curve 210 represents a carbon-doped aluminum oxide film which was deposited at a substrate temperature of 33° C. Curve 212 represents a carbon-doped aluminum oxide film which was deposited at a substrate temperature of 80° C. Curve 214 represents a carbon-doped aluminum oxide film which was deposited at a substrate temperature of 120° C. This graph indicates that there may be an optimum substrate temperature for increasing the carbon content in the deposited carbon-doped aluminum oxide film. That optimum temperature is lower than 120° C. and higher than 33° C., with 65° C. providing a higher carbon content than 55° C.

### Example Two

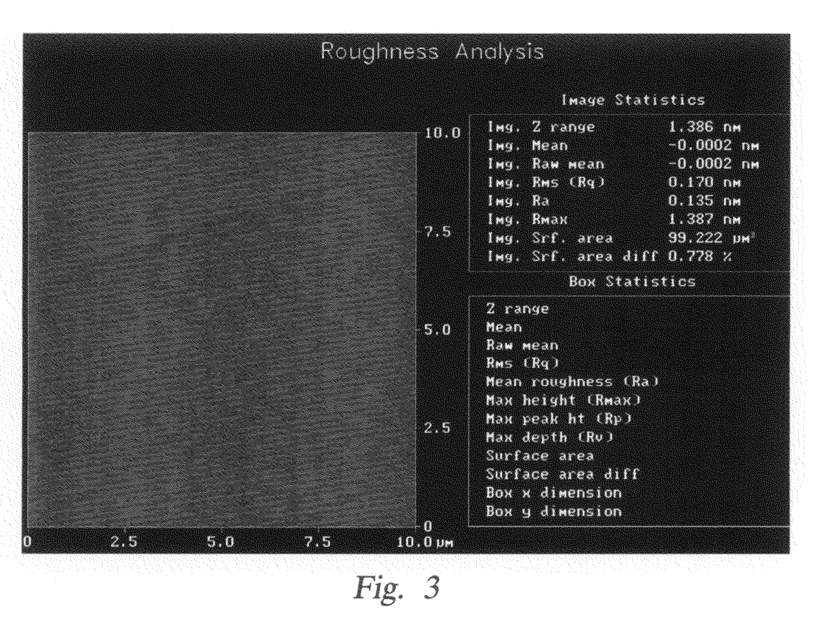

FIG. 3 shows the roughness of a carbon-doped alumina film, as illustrated by an atomic force microscope scan. This film was formed by the method described in Example One. The surface image represents a 10.0 μm by 10.0 μm size. The RMS is 0.17 nm, which is similar to a virgin silicon wafer surface RMS, indicating that the coating is extremely conformal with the surface upon which it is deposited.

### Example Three

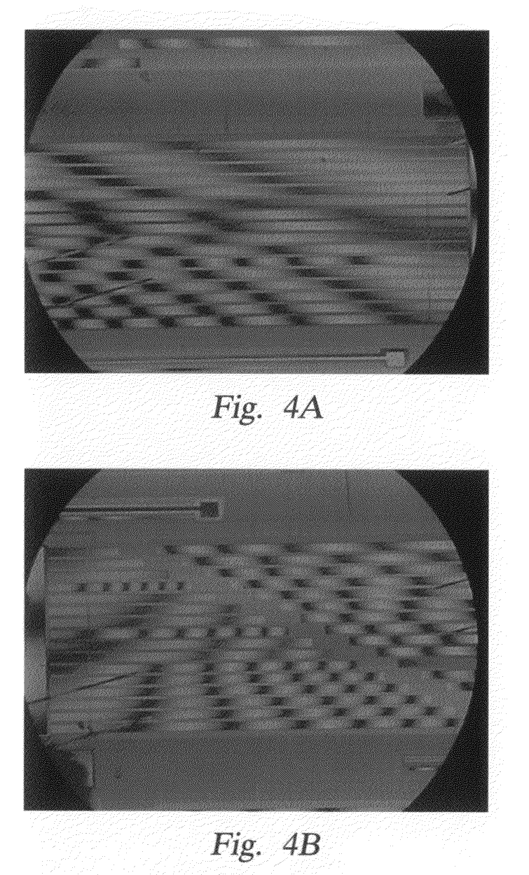

FIGS. 4A and 4B show cantilever beam arrays coated with low temperature carbon-doped aluminum oxide film. The polysilicon detachment length was greater than 1500° m, which corresponds to a work of adhesion which is less than 1 μJ/m². This compares with a work of adhesion in the range of about 20,000 μJ/m² for an oxidized silicon surface. The polysilicon detachment length (which is an indication of stiction properties for a polysilicon cantilever beam), for a 2.5 μm thick, 2 μm gap polysilicon cantilever, coated with the carbon-doped aluminum oxide film of Example One, is greater than 1,500 μm. This compares with a pure aluminum oxide coated polysilicon cantilever of the same thickness and gap size, which exhibits a detachment length of 0 μm. Finally, the coefficient of friction measured for the carbon-doped aluminum oxide film deposited over a silicon substrate (as described with reference to Example One) was 0.1. This compares with an oxidized polysilicon surface which exhibits a coefficient of friction in the range of 1.1. Experimentation has indicated that the coefficient of friction for carbon-doped aluminum oxide films deposited in the manner described in example One, where the carbon atomic % in the film ranges from about 5% to about 20% ranges from about 0.05 to about 0.4.

### Example Three

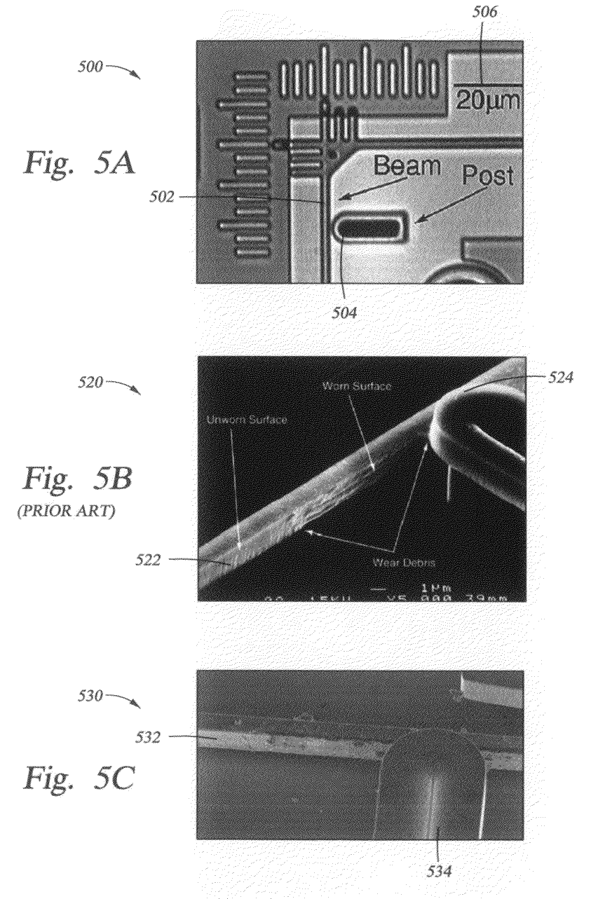

FIG. 5A shows an SEM image of a polysilicon wear testing structure 500, including beam 502 and post 504, which can be used to test sidewall friction along a beam surface, for example. The scale 506 shows 20 μm, illustrating the size of the elements shown.

FIG. 5B shows a comparative view 520 of contacting parts which were coated with vapor deposited DDMS, a beam 522 and a post 524, where the contacting parts were subjected to 250,000 wear cycles. Substantial wear (scarring) is shown on the beam, and wear debris is shown at the edge of the rubbed part of the beam 522 and on the anchored post 524.

FIG. 5C shows an SEM photomicrograph 530 of the contacting parts of a polysilicon substrate coated with a carbon-doped aluminum oxide film, after the contacting beam 532 and post 534 were subjected to 1,000,000 wear cycles. While there is some debris on the surface of contacting beam 532, which may be carbon-related debris, there is no major scarring of the surface of contacting beam 532.

### Example Four

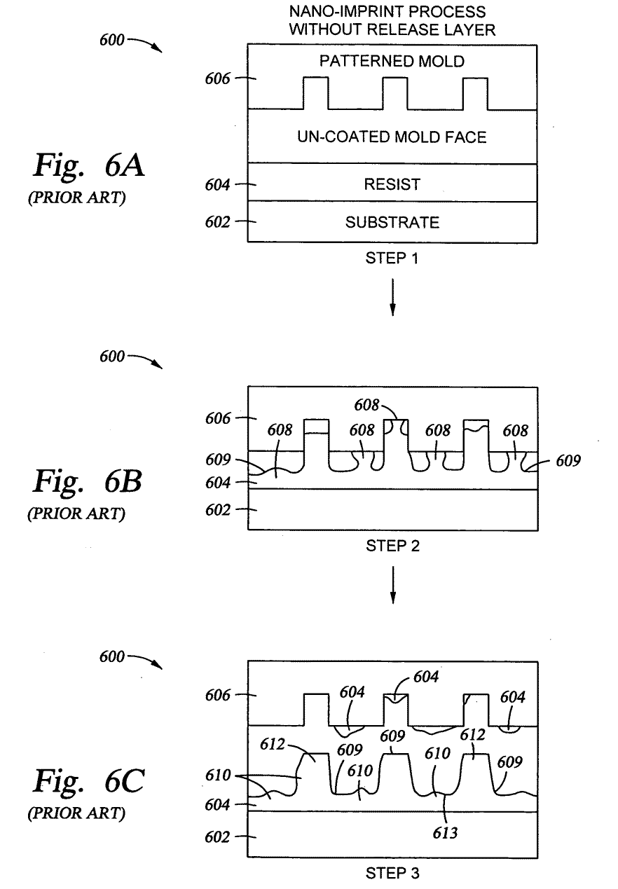

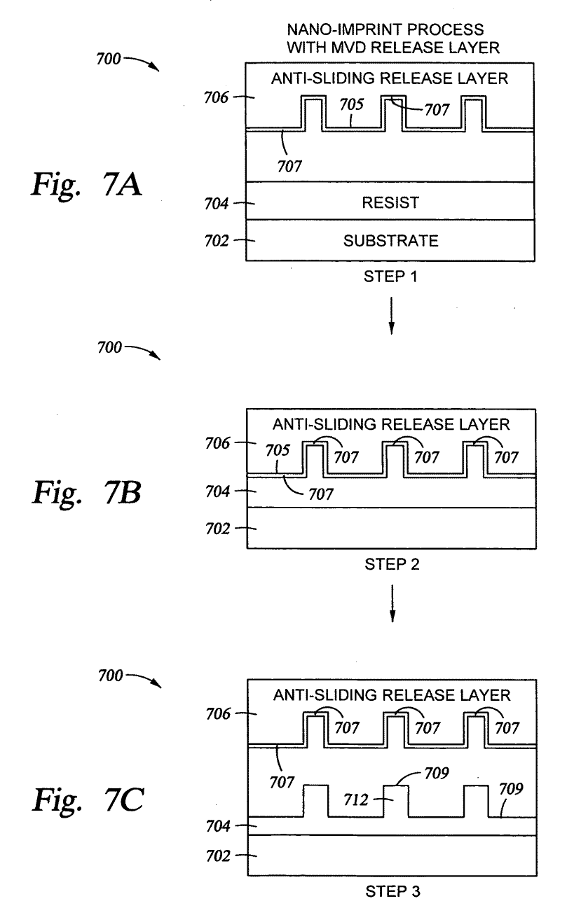

FIGS. 6A-6C show a set of comparative schematics of the steps of the nanoimprint process used prior to the present invention. FIGS. 7A-7C show a set of schematics of the steps of the nanoimprint process employed using the present invention.

FIG. 6 A illustrates step 1 of the prior nanoimprinting process, where 600 shows the assembly used, with a patterned mold 606 positioned above a polymeric material 604 (resist) which is to be patterned. The polymeric material 604 overlies a substrate 602. Typically the substrate is a material such as semiconductors, metals, glasses or polymers, including, for example and not by way of limitation, silicon, nickel, quartz and PDMS (polydimethylsiloxane). The polymeric material 604 is selected from a group of materials known in the art which can be thermally imprinted, and in some instances photocured subsequent to thermal imprinting, to add stability to the imprinted structure. PMMA (Polymethylmethacrylate) and various copolymers thereof have been frequently used as a polymeric material for thermal imprinting. The polymeric material is deposited in the form of a layer over the substrate surface, where the method of deposition may be spin coating with subsequent carrier solvent removal, dipping, or spraying, for example. The thickness of the deposited polymeric material layer is in accordance with the published literature for thermal nanoimprinting and thermal nanoimprinting followed by radiation curing.

FIG. 6B illustrates step 2 of the prior nanoimprinting process, where 600 shows the assembly, where the patterned mold 606 is pressed against the surface of polymeric material 604 to leave an imprint, and then having been partially withdrawn above the surface of polymeric material 604. There is some sticking of the surface of the mold 600 to the surface of polymeric material 604, which has resulted in distortions 608 in the upper surface 609 of polymeric material 604. This problem has been generally discussed within the industry and is seen as the major problem which needs to be solved if thermal nanoimprinting is to be successfully applied.

FIG. 6C illustrates step 3 of the prior nanoimprinting process, where the patterned mold 606 having is withdrawn above the upper surface 609 of polymeric material 604. The shape of the imprint left in polymeric material 604 does not match the inverse shape of the pattern in mold 606, because of sticking of the polymeric material 604 to the mold 606. A number of distortions 610 are present on surface 609 of layer 604 both on the intended raised pattern regions 612 and on the intended lowered pattern regions 613.

FIG. 7 A illustrates step 1 of an embodiment of a nanoimprinting process which employs the present invention. The assembly 700 shows a patterned mold 706, the surface 705 of which is covered with a low surface energy coating 707 of the kind used in the present invention. Mold 706 is positioned above a polymeric material 704 (resist) which is to be patterned. The polymeric material 704 overlies a substrate 702. Typically the substrate is one of the materials named above with reference to FIG. 6A. The polymeric 704 is selected from the group of materials also referenced with respect to FIG. 6A. The polymeric material is deposited in the form of a layer over the substrate surface, where the method of deposition may be one of the methods described with reference to FIG. 6A, by way of example and not by way of limitation.

The low surface energy coating 707 applied over the surface 705 of the mold 706 is a coating of the kind previously described in detail herein, a carbon-doped metal oxide, which has been typically been deposited from a vapor in a process chamber which is at a pressure less than atmospheric pressure, using chemical vapor deposition or atomic layer deposition, which produces an excellent conformal coating. The carbon-doped metal oxide layer or film which is deposited over the mold surface used for the nanoimprinting may be selected from the group consisting of oxides of aluminum, indium, titanium, zirconium, hafnium, tantalum, and combinations thereof, where the carbon content of the carbon-doped metal oxide layer ranges from about 5 atomic % to about 20 atomic %. Typically the carbon content will range from about 10 atomic % to about 20 atomic %. Frequently the carbon content will range from about 10 atomic % to about 15 atomic %.

The carbon-doped metal oxide which is used may be correlated with the polymeric material which makes up the substrate. One of skill in the art of chemistry in general can look at the composition of the substrate and determine, with minimal experimentation, which of the carbon-doped metal oxides will best bond to the substrate surface. Another consideration is whether the surface of the carbon-doped metal oxide layer will corrode under the processing conditions used during the thermal nanoimprinting process. Again, this can be determined by comparing the performance of the carbon-doped oxide materials. The thickness of the carbon-doped metal oxide film ranges from about 5 Å to about 100 Å, depending on the application. Typically the thickness of the carbon-doped metal oxide film ranges from about 5 Å to about 50 Å. Frequently the thickness of the carbon-doped metal oxide film ranges from about 5 Å to about 20 Å.

FIG. 7B illustrates step 2 of the prior nanoimprinting process, where 700 shows the assembly, with the coated surface 705 of mold 706 having been pressed against the surface of polymeric material 704 to leave an imprint.

FIG. 7C illustrates step 3 of the prior nanoimprinting process, where 700 shows the assembly, where the patterned mold 706 is fully withdrawn above the upper surface 709 of polymeric material 704. The shape of the imprint left in polymeric material 704 matches the inverse shape of the pattern in mold 706. There has been no sticking, due to the presence of the carbon-doped metal oxide film 707 present over the surface 705 of mold 706.

While the foregoing is directed to embodiments of the present invention, other and further embodiments of the invention may be devised in view of the present disclosure, without departing from the basic scope of the invention, and the scope thereof is determined by the claims which follow.

We claim:

1. A wear-resistant protective film which provides a coefficient of friction which is less than about 0.4, wherein said film comprises:
a carbon-doped metal oxide film, wherein said metal is selected from the group consisting of aluminum, indium, titanium, zirconium, hafnium, tantalum, and combinations thereof, wherein a carbon content of said carbon-doped film ranges from about 5 atomic % to about 20 atomic %.

2. A wear-resistant protective film in accordance with claim 1, wherein said coefficient of friction ranges from about 0.05 to about 0.4.

3. A wear-resistant protective film in accordance with claim 1, wherein said metal is selected from the group consisting of aluminum, titanium, and combinations thereof.

4. A wear-resistant protective film in accordance with claim 1, wherein said carbon content of said carbon-doped film ranges from about 10 atomic % to about 20 atomic %.

5. A wear-resistant protective film in accordance with claim 2, or claim 3, or claim 4, wherein said film thickness ranges from about 20 Å to about 400 Å.

6. A wear-resistant protective film in accordance with claim 1 or claim 3 or claim 4 applied over a MEMS device surface, wherein a measured work of adhesion for said MEMS device is less than 10 μJ/m².

7. A wear-resistant protective film in accordance with claim 6, wherein said measured work of adhesion ranges from about 10 μJ/m² to about 0.5 μJ/m².

8. A method of depositing a low friction metal oxide film on a substrate, said method comprising: using an atomic layer deposition technique, wherein said metal oxide film is deposited using at least an organo-metallic precursor, and wherein said substrate is at a temperature of 150° C. or lower during deposition of said metal oxide film, whereby a carbon-doped metal oxide film is obtained.

9. A method in accordance with claim 8, wherein said metal oxide film is deposited using an organo-metallic precursor and a water vapor precursor.

10. A method in accordance with claim 8 or claim 9, wherein said substrate temperature ranges from about 25° C. to about 150° C.

11. A method in accordance with claim 10, wherein said substrate temperature ranges from about 25° C. to about 120° C.

12. A method in accordance with claim 11, wherein said substrate temperature ranges from less than about 80° C. to about 55° C.

13. A method in accordance with claim 8 or claim 9, wherein said organo-metallic precursor contains a metal selected from the group consisting of aluminum, indium, titanium, zirconium, hafnium, tantalum, and combinations thereof.

14. A method in accordance with claim 13, wherein said metal is selected from the group consisting of aluminum, titanium, and combinations thereof.

15. A method in accordance with claim 8 or claim 9, wherein a pressure in a processing chamber in which said carbon-doped metal oxide film is deposited ranges from about 0.01 Torr to about 1 Ton during the deposition of said organo-metallic precursor upon said substrate and ranges from about 0.01 Torr to about 5 Ton during the deposition of said water vapor precursor.

16. A method in accordance with claim 15, wherein the time duration of exposure of said substrate to each precursor ranges from about 0.05 seconds to about 30 seconds.

17. A method in accordance with claim 16, wherein deposition of an organometallic precursor followed by deposition of a water vapor precursor is considered to comprise one cycle, and wherein the number of cycles carried out to form said low friction carbon-doped metal oxide film ranges from about 10 to about 100.

18. A method of preventing sticking of a mold to a surface which is to be nanoimprinted, comprising: applying a vapor-deposited carbon-doped metal oxide film over a contact surface of said mold prior to contact with said surface to be nanoimprinted.

19. A method in accordance with claim 18, wherein said vapor deposited, carbon-doped metal oxide is deposited by chemical vapor deposition or by atomic layer deposition.

20. A method in accordance with claim 19, wherein said metal which comprises said metal oxide is selected from the group consisting of aluminum, indium, titanium, zirconium, hafnium, tantalum, and combinations thereof.

21. A method in accordance with claim 20, wherein said metal is selected from the group consisting of aluminum, titanium, and combinations thereof.

22. A method in accordance with claim 20 or claim 21, wherein said carbon-doped metal oxide film has a carbon content ranging from about 10 atomic % to about 20 atomic %.

23. A method in accordance with claim 22, wherein said carbon content ranges from about 10 atomic % to about 15 atomic %.

24. A method in accordance with claim 23, wherein said carbon-doped metal oxide film thickness ranges from about 5 Å to about 100 Å.

25. A method in accordance with claim 24, wherein said carbon-doped metal oxide film thickness ranges from about 5 Å to about 50 Å.

26. A method in accordance with claim 25, wherein said carbon-doped metal oxide film thickness ranges from about 5 Å to about 20 Å.
